(19) United States
(12) Patent Application Publication
(10) Pub. No.: US 2025/0008532 A1
(43) Pub. Date: Jan. 2, 2025

(54) SIDELINK RESOURCE RESERVATION FOR POSITIONING

(71) Applicant: QUALCOMM Incorporated, San Diego, CA (US)

(72) Inventors: Jing DAI, Beijing (CN); Seyedkianoush HOSSEINI, San Diego, CA (US); Alexandros MANOLAKOS, Athens (GR); Chao WEI, Beijing (CN); Weimin DUAN, San Diego, CA (US); Hao XU, Beijing (CN)

(21) Appl. No.: 18/703,954

(22) PCT Filed: Nov. 8, 2021
(86) PCT No.: PCT/CN2021/129213

§ 371 Date: Apr. 23, 2024

(51) Int. Cl. H04W 72/25; H04L 5/00; H04W 64/00

(52) U.S. Cl. CPC H04W 72/25; H04L 5/0048; H04W 64/00

(57) ABSTRACT

In an aspect, a sidelink device may reserve a first sidelink resource for transmission of a first positioning reference signal (PRS) by the sidelink device. The sidelink device may reserve at least one further sidelink resource for transmission of at least one further PRS by at least one further sidelink device, wherein the at least one further sidelink resource occurs within a first time threshold of the first sidelink resource.

### CROSS-REFERENCE TO RELATED APPLICATIONS

The present application for Patent is a national stage application, filed under 35 U.S.C. § 371, of International Patent Application No. PCT/CN2021/129213, entitled, “SIDELINK RESOURCE RESERVATION FOR POSITIONING”, filed Nov. 8, 2021, which is assigned to the assignee hereof and is expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a sidelink device includes reserving a first sidelink resource for transmission of a first positioning reference signal (PRS) by the sidelink device; and reserving at least one further sidelink resource for transmission of at least one further PRS by at least one further sidelink device, wherein the at least one further sidelink resource occurs within a first time threshold of the first sidelink resource.

In an aspect, a sidelink device includes a memory, at least one transceiver; and at least one processor communicatively coupled to the memory and the at least one transceiver, the at least one processor configured to: reserve a first sidelink resource for transmission of a first positioning reference signal (PRS) by the sidelink device; and reserve at least one further sidelink resource for transmission of at least one further PRS by at least one further sidelink device, wherein the at least one further sidelink resource occurs within a first time threshold of the first sidelink resource.

In an aspect, a sidelink device includes means for reserving a first sidelink resource for transmission of a first positioning reference signal (PRS) by the sidelink device; and means for reserving at least one further sidelink resource for transmission of at least one further PRS by at least one further sidelink device, wherein the at least one further sidelink resource occurs within a first time threshold of the first sidelink resource.

In an aspect, a non-transitory computer-readable medium storing computer-executable instructions that, when executed by a sidelink device, cause the sidelink device to: reserve a first sidelink resource for transmission of a first positioning reference signal (PRS) by the sidelink device; and reserve at least one further sidelink resource for transmission of at least one further PRS by at least one further sidelink device, wherein the at least one further sidelink resource occurs within a first time threshold of the first sidelink resource.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system according to aspects of the disclosure.

FIGS. 2A and 2B illustrate example wireless network structures according to aspects of the disclosure.

FIG. 3 is a block diagram illustrating various components of an example user equipment (UE), according to aspects of the disclosure.

FIG. 4 is a diagram illustrating an example frame structure according to aspects of the disclosure.

FIG. 5 illustrates basic sidelink transmission scenarios according to aspects of the disclosure.

FIG. 6 shows example sidelink deployment scenarios according to aspects of the disclosure.

FIG. 7 shows an example resource pool according to aspects of the disclosure.

FIG. 8 depicts an example configuration of symbols of a sidelink resource for a slot of a sub-channel according to aspects of the disclosure.

FIG. 9 is a timing diagram showing an example of Mode 2 resource allocation according to aspects of the disclosure.

FIG. 10 illustrates signals exchanged during an RTT positioning procedure between sidelink UEs according to aspects of the disclosure.

FIG. 11 illustrates signals exchanged during an RTT positioning procedure between sidelink UEs according to aspects of the disclosure.

FIG. 12 illustrates examples of resource reservations satisfying various time patterns according to aspects of the disclosure.

FIG. 13 illustrates examples of resource reservations satisfying various time patterns according to aspects of the disclosure.

FIG. 14 illustrates an example of wireless communication performed by a sidelink device according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device.” a “subscriber device,” a “subscriber terminal,” a “subscriber station.” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an army of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

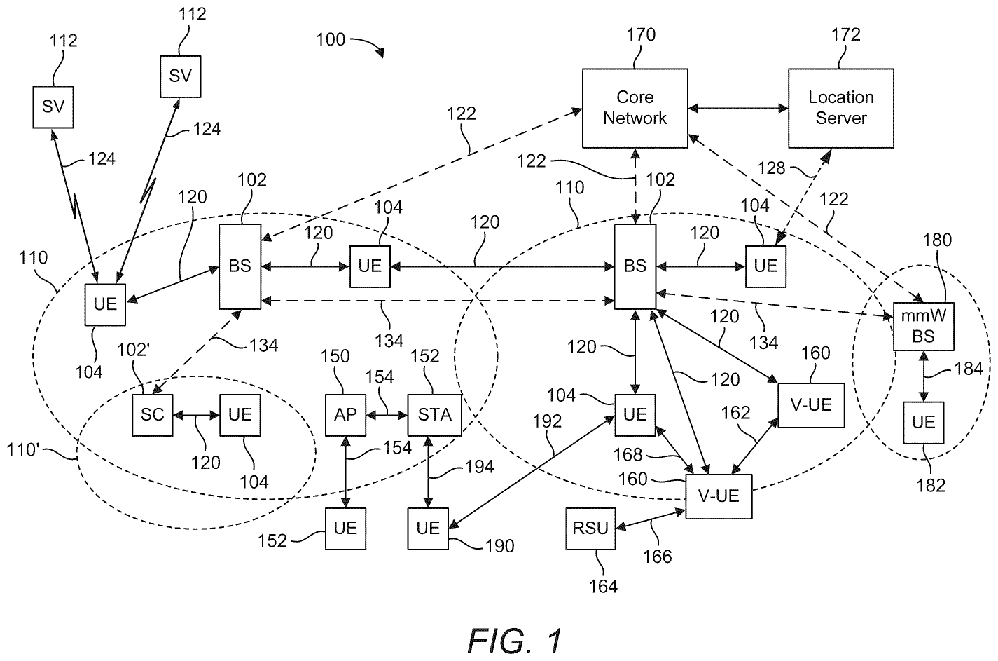

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz—7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz). FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (cV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D). Bluetooth®, and so on. As another example, the D2D P2P links 192 and 194 may be sidelinks, as described above with reference to sidelinks 162, 166, and 168.

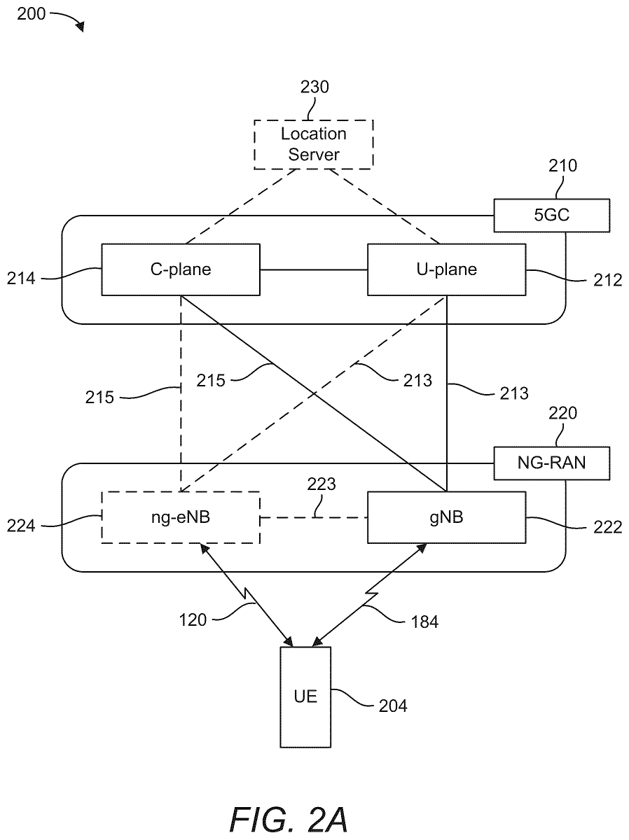

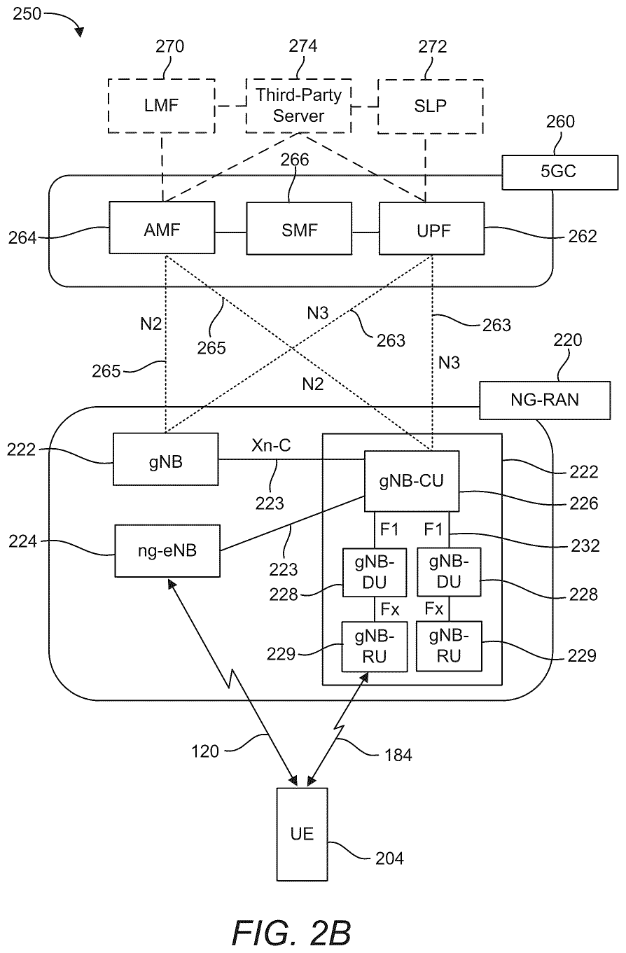

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

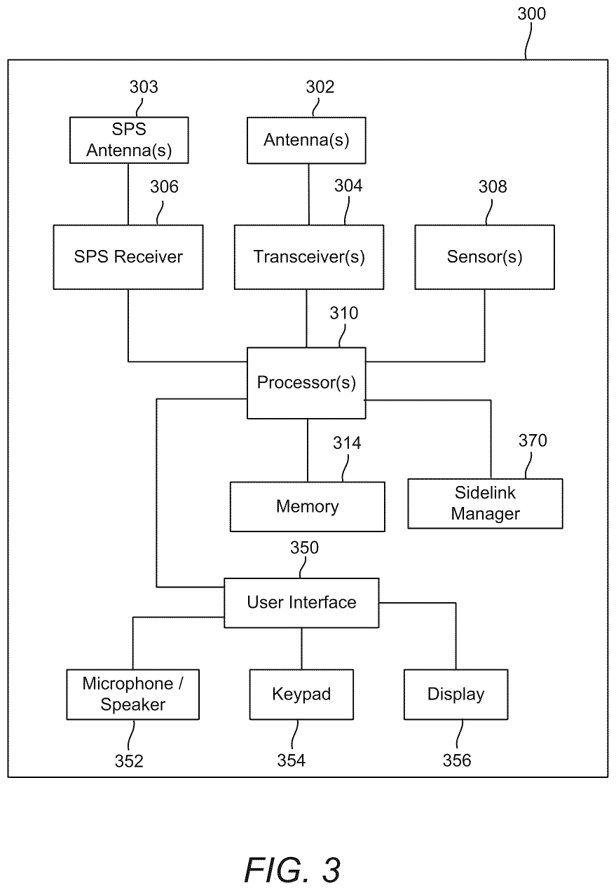

FIG. 3 is a block diagram illustrating various components of an example UE 300, according to aspects of the disclosure. In an aspect, the UE 300 may correspond to any of the UEs described herein. As a specific example, the UE 300 may be a V-UE, such as V-UE 160 in FIG. 1. For the sake of simplicity, the various features and functions illustrated in the block diagram of FIG. 3 are connected together using a common data bus that is meant to represent that these various features and functions are operatively coupled together. Those skilled in the art will recognize that other connections, mechanisms, features, functions, or the like, may be provided and adapted as necessary to operatively couple and configure an actual UE. Further, it is also recognized that one or more of the features or functions illustrated in the example of FIG. 3 may be further subdivided, or two or more of the features or functions illustrated in FIG. 3 may be combined.

The UE 300 may include one or more transceivers 304 connected to one or more antennas 302 and providing means for communicating (e.g., means for transmitting, means for receiving, means for measuring, means for tuning, means for refraining from transmitting, etc.) with other network nodes, such as V-UEs (e.g., V-UEs 160), infrastructure access points (e.g., roadside access unit 164), P-UEs (e.g., UEs 104), base stations (e.g., base stations 102), etc., via at least one designated RAT (e.g., cV2X or IEEE 802.11p) over one or more communication links (e.g., communication links 120, sidelinks 162, 166, 168, mmW communication link 184). The one or more transceivers 304 may be variously configured for transmitting and encoding signals (e.g., messages, indications, information, and so on), and, conversely, for receiving and decoding signals (e.g., messages, indications, information, pilots, and so on) in accordance with the designated RAT. In an aspect, the one or more transceivers 304 and the antenna(s) 302 may form a (wireless) communication interface of the UE 300.

As used herein, a “transceiver” may include at least one transmitter and at least one receiver in an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antenna(s) 302), such as an antenna array, that permits the UE 300 to perform transmit “beamforming,” as described herein. Similarly, a receiver may include or be coupled to a plurality of antennas (e.g., antenna(s) 302), such as an antenna array, that permits the UE 300 to perform receive beamforming, as described herein. In an aspect, the transmitter(s) and receiver(s) may share the same plurality of antennas (e.g., antenna(s) 302), such that the UE 300 can only receive or transmit at a given time, not both at the same time. In some cases, a transceiver may not provide both transmit and receive functionalities. For example, a low functionality receiver circuit may be employed in some designs to reduce costs when providing full communication is not necessary (e.g., a receiver chip or similar circuitry simply providing low-level sniffing).

The UE 300 may also include a satellite positioning system (SPS) receiver 306. The SPS receiver 306 may be connected to the one or more SPS antennas 303 and may provide means for receiving and/or measuring satellite signals. The SPS receiver 306 may comprise any suitable hardware and/or software for receiving and processing SPS signals, such as global positioning system (GPS) signals. The SPS receiver 306 requests information and operations as appropriate from the other systems, and performs the calculations necessary to determine the UE's 300 position using measurements obtained by any suitable SPS algorithm.

One or more sensors 308 may be coupled to one or more processors 310 and may provide means for sensing or detecting information related to the state and/or environment of the UE 300, such as speed, heading (e.g., compass heading), headlight status, gas mileage, etc. By way of example, the one or more sensors 308 may include a speedometer, a tachometer, an accelerometer (e.g., a microelectromechanical systems (MEMS) device), a gyroscope, a geomagnetic sensor (e.g., a compass), an altimeter (e.g., a barometric pressure altimeter), etc.

The one or more processors 310 may include one or more central processing units (CPUs), microprocessors, microcontrollers, ASICs, processing cores, digital signal processors (DSPs), field-programmable gate arrays (FPGAs), or the like that provide processing functions, as well as other calculation and control functionality. The one or more processors 310 may therefore provide means for processing, such as means for determining, means for calculating, means for receiving, means for transmitting, means for indicating, etc. The one or more processors 310 may include any form of logic suitable for performing, or causing the components of the UE 300 to perform, at least the techniques described herein.

The one or more processors 310 may also be coupled to a memory 314 providing means for storing (including means for retrieving, means for maintaining, etc.) data and software instructions for executing programmed functionality within the UE 300. The memory 314 may be on-board the one or more processors 310 (e.g., within the same integrated circuit (IC) package), and/or the memory 314 may be external to the one or more processors 310 and functionally coupled over a data bus.

The UE 300 may include a user interface 350 that provides any suitable interface systems, such as a microphone/speaker 352, keypad 354, and display 356 that allow user interaction with the UE 300. The microphone/speaker 352 may provide for voice communication services with the UE 300. The keypad 354 may comprise any suitable buttons for user input to the UE 300. The display 356 may comprise any suitable display, such as, for example, a backlit liquid crystal display (LCD), and may further include a touch screen display for additional user input modes. The user interface 350 may therefore be a means for providing indications (e.g., audible and/or visual indications) to a user and/or for receiving user input (e.g., via user actuation of a sensing device such a keypad, a touch screen, a microphone, and so on).

In an aspect, the UE 300 may include a sidelink manager 370 coupled to the one or more processors 310. The sidelink manager 370 may be a hardware, software, or firmware component that, when executed, causes the UE 300 to perform the operations described herein. For example, the sidelink manager 370 may be a software module stored in memory 314 and executable by the one or more processors 310. As another example, the sidelink manager 370 may be a hardware circuit (e.g., an ASIC, a field-programmable gate array (FPGA), etc.) within the UE 300.

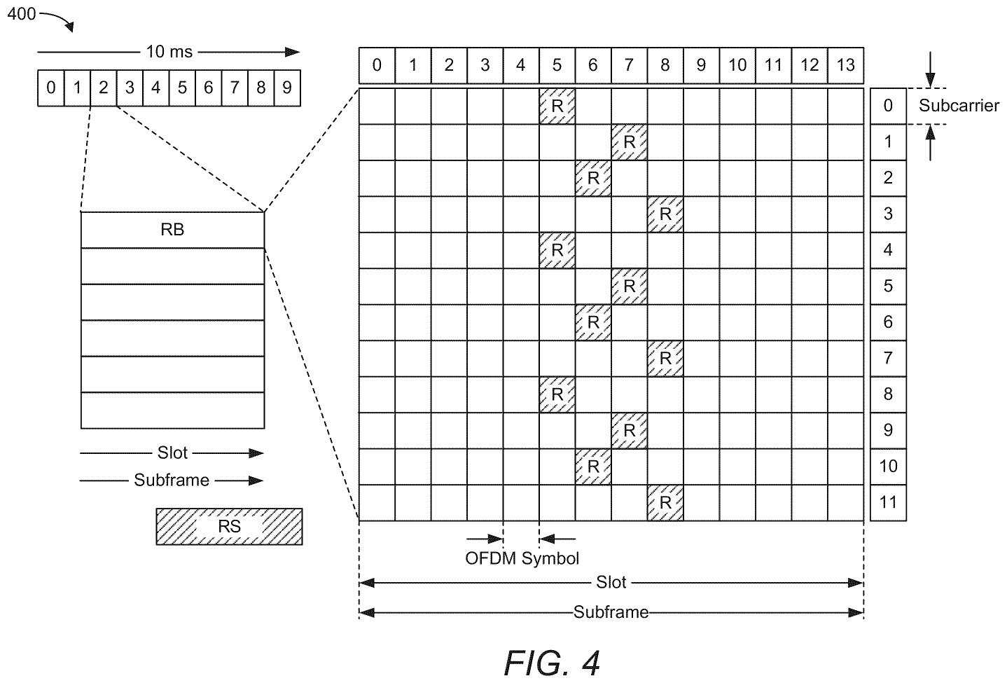

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Such frame structures are also used in sidelink communications between UEs. Other wireless communications technologies may have different frame structures and/or different channels.

LTE, and in some cases NR, utilizes OFDM on the downlink and single-carrier frequency division multiplexing (SC-FDM) on the uplink. Unlike LTE, however. NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

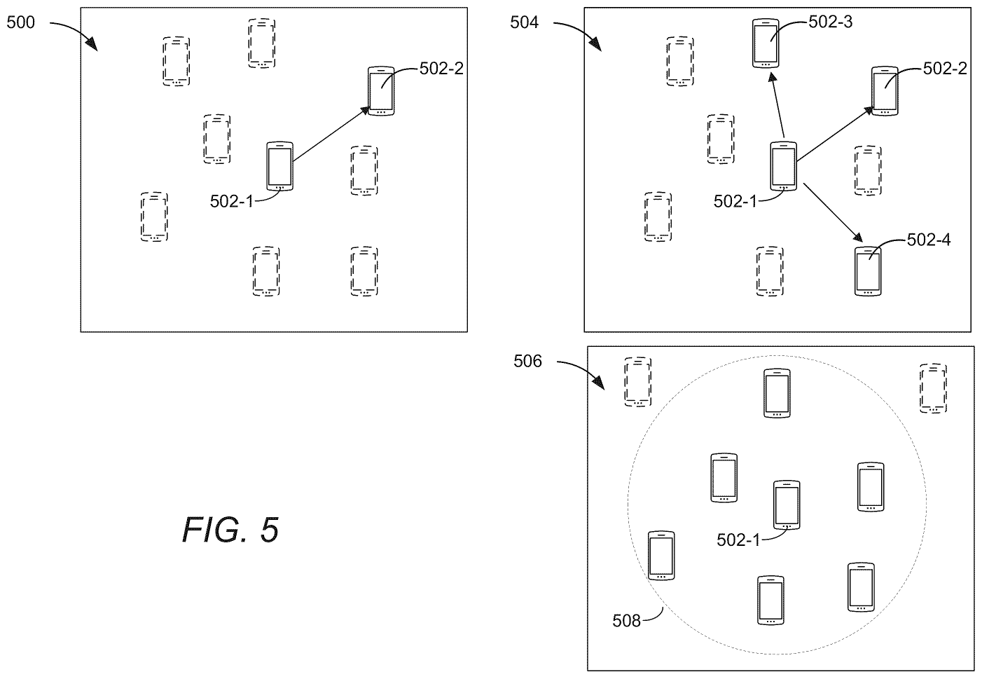

NR sidelink supports three basic transmission scenarios 1) unicast, in which case the sidelink transmission targets a specific receiving device, 2) groupcast, in which case the sidelink transmission targets a specific group of receiving devices, and 3) broadcast, in which case the sidelink transmission targets any device that is within the range of the transmission. FIG. 5 illustrates basic transmission scenarios in accordance with certain aspects of the disclosure. Transmission scenario 500 shows a unicast scenario in which UE 502-1 has targeted UE 502-2 for communication to the exclusion of other UEs in the environment. Transmission scenario 504 shows a group cast a scenario in which UE 502-1 has targeted UE 502-2, UE 502-3, and UE 502-4 for targeted communications. Transmission scenario 506 shows a broadcast scenario in which all UEs within the transmission range 508 of UE 502-1 are targeted for transmission.

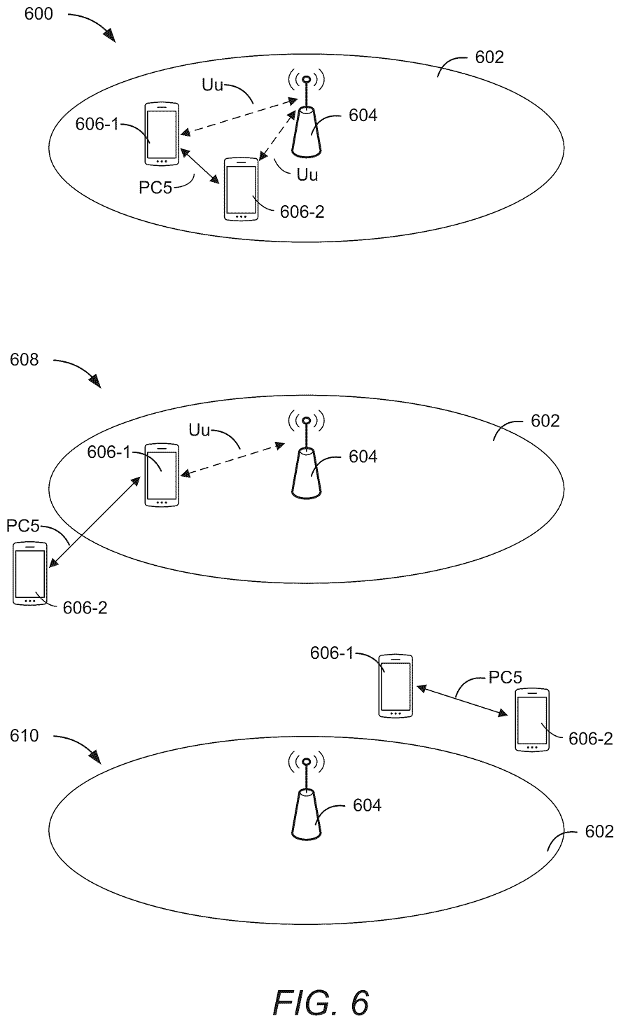

Generally, there are three deployment scenarios for NR sidelink communication in terms of the relation between the sidelink communication and an overlaid cellular network. FIG. 6 shows three such deployment scenarios in accordance with certain aspects of the disclosure. Deployment scenario 600 shows an in-coverage scenario in which both UE 606-1 and UE 606-2 are within the coverage 602 of a base station 604 and communicate with the base station 604 via Uu links. In deployment scenario 600, the UEs 606-1 and 606-2 communicate with one another via a PC5 link. To a smaller or larger extent, depending on the exact mode-of-operation of the UEs 606-1 and 606-2, the base station 604 may control the sidelink communications. Deployment scenario 608 shows a partial coverage scenario in which UE 606-1 is within coverage 602 and communicates with the base station 604 over a Uu link. In deployment scenario 608, the UEs 606-1 and 606-2 are within the communication range of one another and communicate via a PC5 link. In an aspect, UE 606-1 may act as a relay for communications between base station 604 and UE 606-2. Deployment scenario 610 shows out-of-coverage operation in which neither UE 606-1 nor UE 606-2 are within coverage 602 but are nevertheless within communication range of one another over a PC5 link.

Similar to downlink and uplink transmissions that take place over a Uu link, sidelink transmissions take place over a set of physical channels on to which a transport channel is mapped and/or which carry different types of L1/L2 control signaling. The physical channels include 1) a physical sidelink shared channel (PSSCH), 2) a physical sidelink control channel (PSCCH), 3) a physical sidelink broadcast channel (PSBCH), and 4) the physical sidelink feedback channel (PSFCH). The PSCCH carries control information in the sidelink. The PSSCH carries data payload in the sidelink and additional control information. The PSBCH carries information for supporting synchronization in the sidelink. PSBCH is sent within a sidelink synchronization signal block (S-SSB). The PSFCH carries feedback related to the successful or failed reception of a sidelink transmission.

Furthermore, NR sidelink communications support various signals, including reference signals, that are carried in or associated with the physical channels. In this regard, a DMRS is used by a sidelink receiver for decoding the associated sidelink physical channel, i.e., PSCCH, PSSCH, PSBCH. The DMRS is sent within the associated sidelink physical channel. A sidelink primary synchronization signal (S-PSS) and sidelink secondary synchronization signal (S-SSS) may be used by a sidelink receiver to synchronize to the transmitter of these signals. S-PSS and S-SSS are sent within the S-SSB. Sidelink Channel state information reference signals (SL CSI-RS) are used for measuring channel state information (CSI) at the receiver that is then fed back to the transmitter. The transmitter adjusts its transmission based on the fed-back CSI. SL CSI-RS is sent within the PSSCH region of the slot. Sidelink Phase-tracking reference signals (SL PT-RS) are used for mitigating the effect of phase noise (in particular at higher frequencies) resulting from imperfections of the oscillator. SL PT-RS is sent within the PSSCH region of the slot. Sidelink positioning reference signals (S-PRS) are used to conduct positioning operations to determine the absolute position of a sidelink device and/or the relative position of a sidelink device with respect to other sidelink devices. The S-PRS is sent within the PSSCH region of the slot.

In NR, only certain time and frequency resources are (pre-)configured to accommodate SL transmissions. The subset of the available SL resources is (pre-)configured to be used by several UEs for their SL transmissions. This subset of available SL resources is referred to as a resource pool.

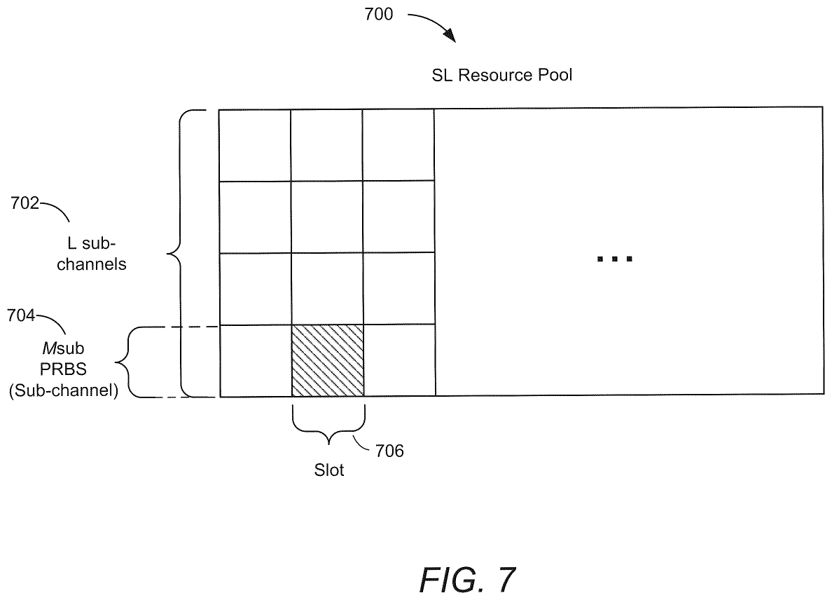

FIG. 7 shows an example resource pool 700 in accordance with certain aspects of the disclosure. A resource pool consists of contiguous PRBs and contiguous or non-contiguous slots that have been (pre-)configured for SL transmissions. In the frequency domain, a resource pool is divided into a (pre-)configured number L of contiguous sub-channels 702, where a sub-channel 704 consists of a group of consecutive PRBs in a slot 706. The number Msub of PRBs in a sub-channel corresponds to the sub-channel size, which is (pre-)configured within the resource pool 700. In an aspect, the sub-channel size Msub can be equal to 10, 12, 15, 20, 25, 50, 75, or 100 PRBs. A sub-channel represents the smallest frequency domain unit for a sidelink data transmission or reception. A sidelink transmission can use one or multiple sub-channels. In the time domain, the slots that are part of a resource pool are (pre-)configured and occur on a periodic basis. In the example of FIG. 7, sidelink resources are shown as individual resource pool elements 702, where each resource for element consists of a single slot 704 over a sub-channel 704 comprised of a set of common physical resource blocks (PRBS).

In an aspect, the slot 706 of a sub-channel only allocates a subset of its consecutive symbols (pre-)configured for sidelink communications. The subset of SL symbols per slot is indicated with a starting symbol and a number of consecutive symbols, where these two parameters are (pre-)configured per the resource pool. The number of consecutive SL symbols can vary between 7 and 14 symbols depending on the physical channels which are carried within a slot.

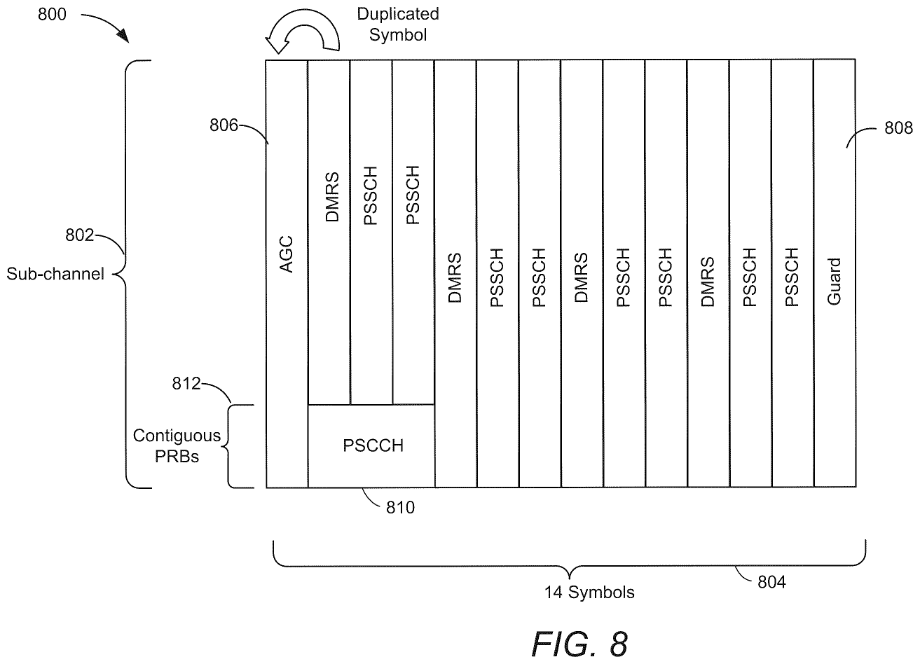

FIG. 8 depicts an example configuration of symbols of a SL resource 800 for a slot of a sub-channel in accordance with certain aspects of the disclosure. In this example, the configuration is directed to a single sub-channel 802 and a single slot 804. Here, slot 804 comprises 14 symbols including 3 PSCCH symbols and 12 PSSCH symbols. The example slot 804 includes 4 DMRS symbols which are carried in the PSSCH symbols. Among other data, the PSSCH carries the 1^{st}-stage-SCI as discussed in further detail herein. The first symbol carried by each PRB of the SL resource 800 is an automatic gain control (AGC) symbol 806, which is used by the sidelink device for automatic gain control operations. In an aspect, the AGC symbol 806 may be a duplicate of the second symbol carried by each PRB of the sub-channel in 802. The last symbol carried by each PRB of the SL resource 800 is a guard symbol 808, which does not carry any sidelink data. The SL resource 800 includes a configurable number of contiguous PRBs and symbols for carrying the PSSCH 810. In this example, the PSSCH 810 is carried in the second, third, and fourth symbols of a plurality of contiguous PRBs 812.

With reference again to FIG. 8, the SL resource pool 800 can be shared by several UEs for their SL transmissions. The SL resources of the SL resource pool 800 can be used for all transmission types (i.e., unicast, groupcast, and broadcast). A UE can be (pre-) configured with multiple resource pools for transmission (e.g., transmit resource pools (RPs)) and with multiple resource pools for reception (e.g., receive resource RPs). A UE can receive data on resource pools used for SL transmissions by other UEs and transmit on the SL using its transmit RPs. In certain aspects, exceptional transmit RPs are configured for the UEs for situations that include when a UE is in a transition from idle to connected mode, when a UE experiences a link failure or a handover, or when a UE is changing between different configured transmit RPs. The use of exceptional transmit RPs in such situations aids in improving service continuity.

NR defines two resource allocation modes for sidelink communications, one centralized (Mode 1) and one distributed (Mode 2). In Mode 1, the base station (e.g., gNB) schedules sidelink resources to be used by the UE for sidelink transmissions. However, in Mode 2, the UE autonomously determines which sidelink resources of a resource pool the UE will use for transmissions.

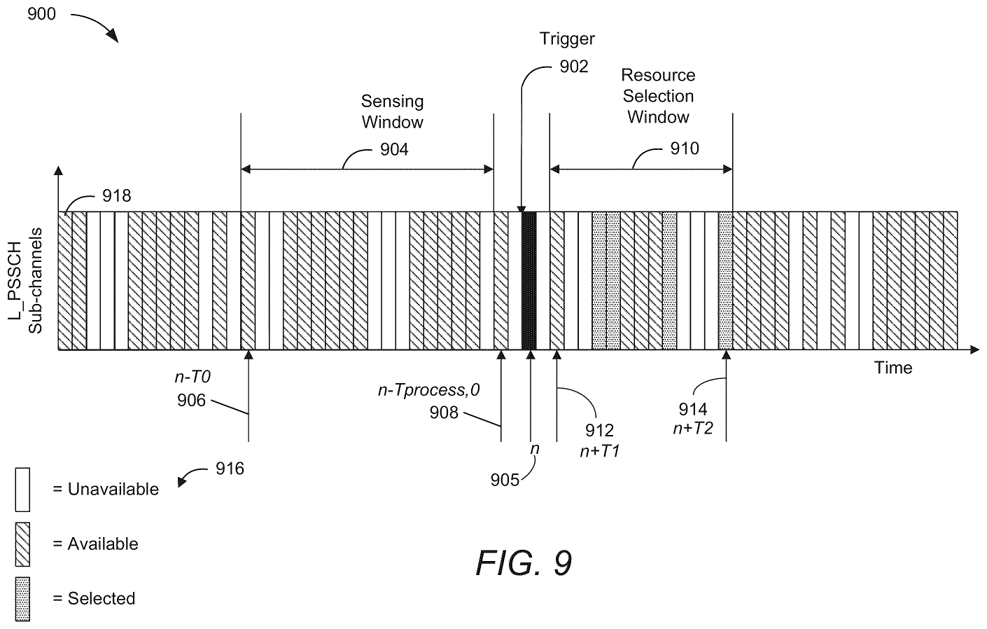

FIG. 9 is a timing diagram 900 showing an example of how SL resources may be allocated in accordance with certain aspects of the disclosure. In Mode 2, the UEs autonomously select their SL resources from a resource pool and can operate without network coverage, such as shown in the example scenario 610 of FIG. 6. The resource pool used by the UEs can be (pre-)configured by a gNB or eNB when the UE is in network coverage or pre-configured as part of the UE design.

Mode 2 uses sensing-based semi-persistent scheduling SPS for periodic traffic. The sensing procedure takes advantage of the periodic and predictable nature of basic sidelink service messages. In sensing-based SPS, the UEs reserve sub-channels in the frequency domain for a random number of consecutive periodic transmissions in the time domain. The number of slots for transmission and retransmissions within each periodic resource reservation period depends on the resource selection procedure. The number of reserved sub-channels per slot depends on the size of data to be transmitted.

The sensing-based resource selection procedure is composed of two stages: 1) a sensing procedure and 2) a resource selection procedure. In the example shown in FIG. 9, the procedures are executed in response to a trigger event 902. The trigger event 902 may coincide with a number of different event types. In certain aspects, the trigger event 902 may occur on a configurable periodic basis. In certain aspects, the trigger event 902 occurs when a particular task is executed by the UE, such as a positioning operation executed by the UE. A UE can also select new SL resources in response to a re-evaluation or pre-emption condition. For purposes of the following discussion, the resource allocation process originates at slot n 905, shown here as the first slot after the trigger event 902.

The sensing procedure is in charge of identifying the resources which are candidates for resource selection and is based on the decoding of the 1st-stage-SCI received from the surrounding UEs and on sidelink power measurements in terms of RSRP. The sensing procedure is performed during a sensing window 904, which is defined by a pre-configured parameter 7V and a specific parameter Tproc,0. The specific parameter Tproc,0 accounts for the time required by the UE to complete decoding the SCIs from other UEs and perform measurements on DMRS of signals transmitted on resources of the other UEs. As shown in FIG. 9, with respect to slot n 905, the UE will consider the sidelink RSRP measurements performed during the interval n-T0 906 to n-Tproc,0 908. Sidelink RSRP measurements can be computed using the power spectral density of the signal received in the PSCCH or in the PSSCH, for which the UE has successfully decoded the 1st-stage-SCI. PSCCH RSRP and PSSCH RSRP are determined as the linear average over the power contributions (in Watts) of the resource elements that carry the DMRS associated with PSCCH and PSSCH, respectively.

Based on the information extracted from the sensing operations, the resource selection procedure determines the resource(s) that the UE may use sidelink transmissions. For that purpose, another interval known as the resource selection window 910 is defined. The resource selection window 910 is defined by the interval n+T1 912 and n+T2 914, where T1 and T2 are two parameters that are determined by the UE implementation. In certain aspects, the value of T2 depends on a packet delay budget (PDB) and on an RRC pre-configured parameter called T2.min. In the case that PDB>T2 min, T2 is determined by the UE implementation and must meet the following condition: T2,min≤T2≤PDB. In the case that PDB≤T2, min, then T2=PDB. T is selected so that Tproc,1≤T1, where Tproc,1 is the time required to identify the candidate resources and reserve a subset of resources for sidelink transmission.

The resource selection procedure is composed of two steps. First, the candidate resources within the resource selection window 910 are identified. A resource is indicated as a non-candidate if an SCI is received on that slot or the corresponding slot is reserved by a previous SCI, and the associated sidelink RSRP measurement is above a sidelink RSRP threshold. The resulting set of candidate resources within the resource selection window 910 should be at least X % of the total resources within the resource selection window 910 to proceed with the second step of the resource selection process. The value of X is configured by RRC and, in certain aspects, can be 20%, 35% or 50%. If this condition is not met, the RSRP threshold may be increased by a predetermined amount, such as 3 dB, and the procedure is repeated. Second, the transmitting UE performs the resource selection from the identified candidate resources by reserving the selected resources in its SCI transmission. To exclude resources from the candidate pool based on sidelink measurements in previous slots, the resource reservation period (which is transmitted by the UEs in the 1st-stage-SCI) is introduced. As only the periodicity of transmissions can be extracted from the SCI, the UE that performs the resource selection uses this periodicity (if included in the decoded SCI) and assumes that the UE(s) that transmitted the SCI will do periodic transmissions with such a periodicity, during Q periods. This allows to identify and exclude the non-candidate resources of the resource selection window 910. In accordance with certain aspects of the disclosure,

$$Q = [ \frac{Tscal}{Prsvp} ] ,$$

where Prsvp refers to the resource reservation period decoded from the SCI, and Tscal corresponds to T2 converted to units of milliseconds (ms).

A sidelink resource, such as sidelink resource 918, is defined by one slot in time and L_{PSSCH} contiguous sub-channels in frequency. L_{PSSCH} is an integer in the range 1≤L_{PSSCH}≤max(L_{PSSCH}), where max(L_{PSSCH}) is the total number of sub-channels per slot in the resource selection window 910. However, in certain aspects, the value of max(L_{PSSCH}) can be modified by a congestion control process.

In the example resource allocation process of FIG. 9, T0=20 slots, Tproc,0=2 slots, T1=2 slots, and T2=16 slots. Once the resource selection is triggered at slot n, based on the measurements in the sensing window 904, the UE reserves sidelink resources within the resource selection window 910 for its own transmissions. Visual indicia corresponding to whether a sidelink resource is available, unavailable, or selected (e.g., reserved) in the example are shown in legend 916.

In accordance with certain aspects of the disclosure, the UE may reserve sidelink resources for itself as well as for other UEs. In certain aspects, the UE transmits one or more signals to other UEs indicating that the UE has reserved specific resources on behalf of the other UEs. In an aspect, other UEs would also monitor the resource pool and decode the PSCCH sent by the UE for the reservation. In accordance with certain aspects of the disclosure, the UE may reserve sidelink resources for transmitting its own PRS and request that other UEs transmit PRS using the sidelink resources reserved by the UE on behalf of the other UEs. In such instances, the UE effectively schedules the PRS resources that are to be used in positioning operations.

NR supports a number of positioning technologies, including downlink-based, uplink-based, and downlink-and-uplink-based positioning methods. Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

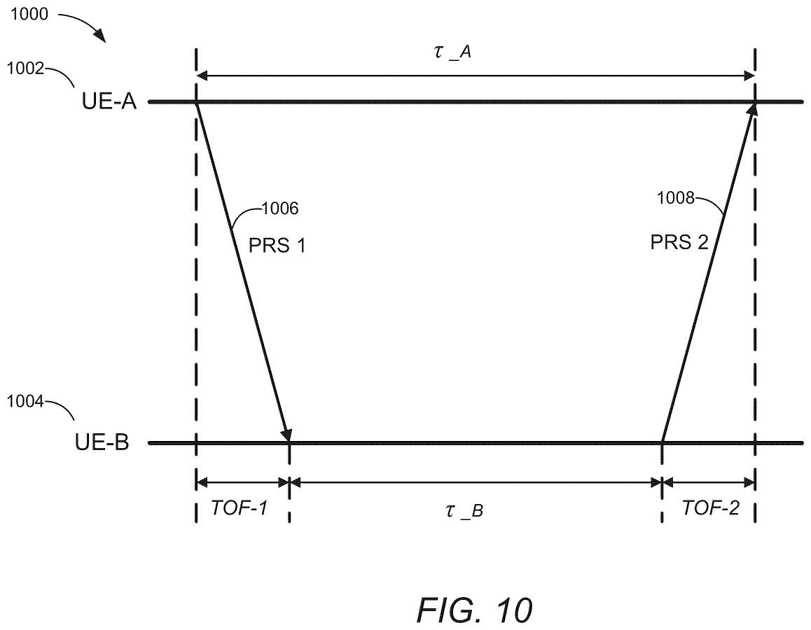

NR supports RTT positioning between UEs over sidelink communications in Mode 2. The accuracy of RTT measurements made by the UEs in Mode 2 is related to the clock drift of the clocks used by the UEs in making their measurements. Certain aspects of the disclosure minimize the impact of clock drift errors that occur during the positioning operations between sidelink devices, such as RTT positioning operations that take place between two or more sidelink UEs. FIG. 10 illustrates signals exchanged during an RTT positioning procedure 1000 between sidelink UEs in accordance with certain aspects of the disclosure. In this example, the positioning operations take place between UE-A 1002 and UE-B 1004, where UE-A 1002 transmits PRS 1 1006, which is received by UE-B 1004 after a first time-of-flight duration TOF-1. After a time duration τ_{B} as measured by the UE-B's clock, UE-B 1004 transmits PRS 2 1008, which is received by UE-A 1002 after a second time-of-flight TOF-2. In this example, the interval between the time at which UE-A 1002 transmits PRS 1 1006 and the time at which it receives PRS 2 1008 from UE-B 1004 is as τ_{A} measured by UE-A's clock. Throughout the figures, any text in the figures following an underscore is understood to be formatted as a subscript and is expressed as a subscript in the text of this disclosure. As such, τₑ shown as τ_B and τ_{A} is shown as τ_B in FIG. 10.

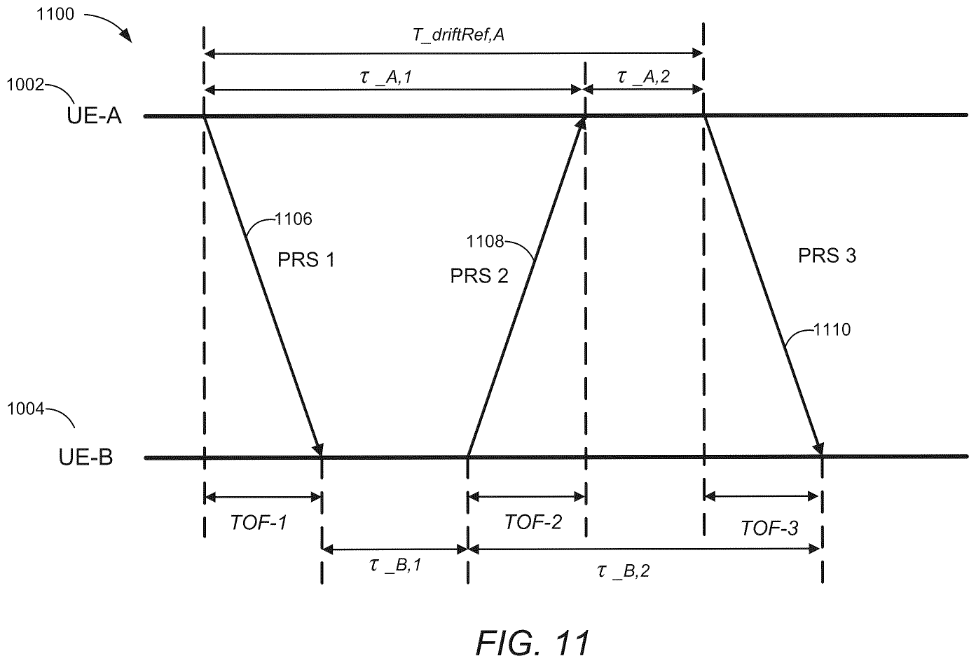

FIG. 11 illustrates signals exchanged during an RTT positioning procedure 1100 between sidelink UEs in accordance with certain aspects of the disclosure. In this example, three PRS transmissions are used for the positioning determination. The positioning operations again take place between UE-A 1002 and UE-B 1004, where UE-A 1002 transmits PRS 1 1106, which is received by UE-B 1004 after a first time-of-flight duration TOF-1. After a time duration τ_{B,1} as measured by the UE-B's clock, UE-B in 1104 transmits PRS 2 1108, which is received by UE-A 1002 after a second time-of-flight duration TOF-2. In this example, the interval between the time at which UE-A 1002 transmits PRS 1 1106 and the time at which it receives PRS 2 1108 from UE-B 1004 is τ_{A,1} as measured by UE-A's clock. After a time duration τ_{A,2}. UE-A 1002 transmits PRS 3 1110, which is received by UE-B 1004 after a third time-of-flight duration TOF-3. The interval between the time at which UE-B 1004 transmits PRS 2 1108 and the time at which UE-B 1904 receives PRS 3 1110 is τ_{B,2} as measured by UE-B 1004.

Ideally, the clocks of all UEs involved in the RTT positioning do not experience clock drift. In such instances, the RTT measurement is unaffected by clock drift occurring during the durations between the transmissions and receptions of the PRS (e.g., τ_{A} and τ_{B} of FIG. 11). However, as a practical matter, all UEs experience clock drift. The clock drift can be modeled as \hat{τ}=(1−e)τ, where \hat{τ} is the actual measurement of a duration τ using a clock having an unknown deviation e from the ideal time due to clock drift. As such, the measured RTT time differs from the actual RTT time T_{RTT} by an amount \hat{T}_{RTT} due to clock drift.

Certain aspects of the disclosure recognize that the magnitude of the RTT error \hat{T}_{RTT} depends on the clock drift occurring during the intervals between the transmissions and receptions of the PRS as measured by each UE. Applying the clock drift model to the example in FIG. 11, results in the following determinations:

$${\hat{T}}_{RTT} = {\hat{τ}}_{A} - {\hat{τ}}_{B} , where$$

$${\hat{τ}}_{A} = ( 1 + {e}_{A} ) {τ}_{A} , and$$

$${\hat{τ}}_{B} = ( 1 + {e}_{B} ) {τ}_{B} .$$

This results in an estimation error corresponding to:

$${\hat{T}}_{RTT} - {T}_{RTT} = ( {\hat{τ}}_{A} - {\hat{τ}}_{B} ) - ( {τ}_{A} - {τ}_{B} ) = ( {e}_{A} {τ}_{A} - {e}_{B} {τ}_{B} ) = {e}_{A} {T}_{RTT} + ( {e}_{A} - {e}_{B} ) {τ}_{B} .$$

As per certain 3GPP standards, the worst-case drift tolerated for e is ±0.1 parts per million (ppm). Assuming τ_{B}=100 ms and a worst case clock drift of e_{A}−e_{B}=±0.2 ppm, the estimation error can be as high as 20 nanoseconds (nsecs), where 10 nsecs for a single-round propagation delay corresponds to a distance of 3 meters.

In accordance with certain aspects of the disclosure, a first UE engaged in Mode 2 sidelink positioning operations with a second UE reserves sidelink resources for PRS transmissions for both the first UE and the second UE. The sidelink resources are selected and reserved based on the time intervals between the sidelink resources. In an aspect, the first UE selects sidelink resources having time patterns falling within time intervals that minimize the value of \hat{T}_{RTT} to an acceptable value. In accordance with certain aspects, an acceptable value for \hat{T}_{RTT} depends on the positioning precision required in a given circumstance, where circumstances requiring a high degree of precision require a lower value for \hat{T}_{RTT} than circumstances requiring a lesser degree of precision. The first UE reserves sidelink resources that meet one or more interval criteria as resources for PRS transmissions sent by the first and second UEs.

In accordance with certain aspects of the disclosure, a baseline single-sided algorithm may be used to calculate T_{RTT} using the measurements obtained during the positioning operations shown in FIG. 11. Using this algorithm, the error due to clock drift corresponds to \hat{T}_{RTT}=\hat{τ}_{A}−\hat{τ}_{B}, which deviates from the actual T_{RTT}. The relationship between \hat{T}_{RTT} and T_{RTT} can be expressed as \hat{T}_{RTT}=e_{A}T_{RTT}+(e_{A}−e_{B})τ_{B,1}. Certain aspects of the disclosure recognize that T_{RTT} is typically on the order of microseconds (usecs), whereas τ_{B} is on the order of msecs. As such, the (e_{A}−e_{B}) τ_{B} portion of the equation constitutes the dominant part of the clock drift error. Accordingly, during resource allocation operations (e.g., the resource allocation operations shown and described with respect to FIG. 9), UE-A 1002 reserves sidelink resources to minimize the duration of τ_{B}. To this end, the time interval between the reception of PRS 1 1006 and transmission of PRS 2 1008 should be no larger than a specified first time threshold Tₜₕ₁, where Tₜₕ₁ is small enough to mitigate the dominant part of the time drift error. As an example, for positioning operations requiring a 1 meter (m) accuracy and having a 10% error budget, the maximum value for Tₕₜᵣₑₛ₁ can be determined as:

$${T}_{th 1} = \frac{1 * 10 \%}{0.1 ppm * c} = 3.3 m sec$$

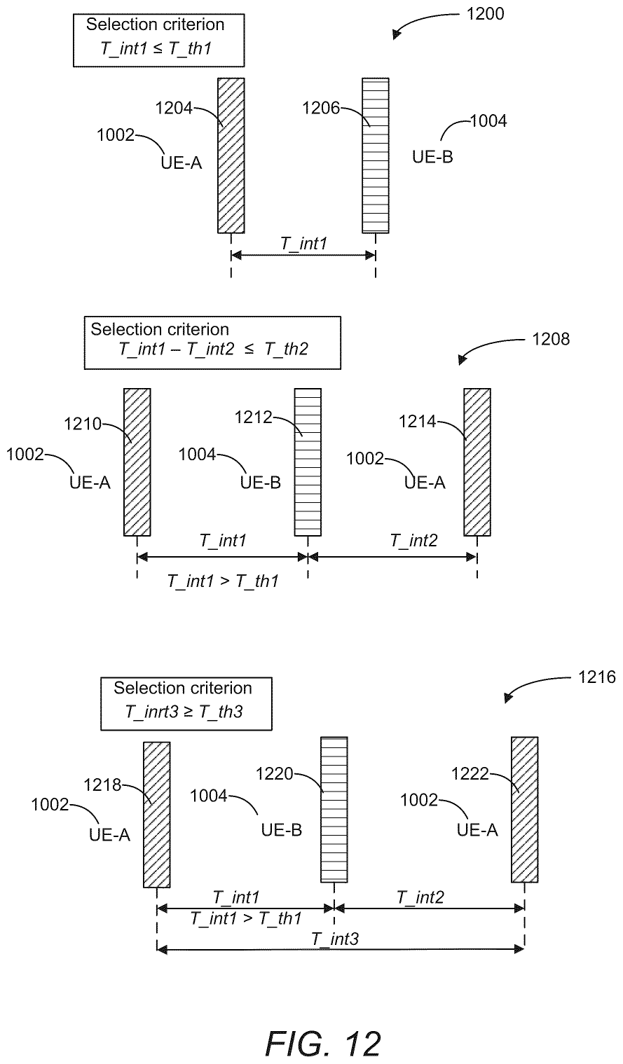

An example of a resource reservation meeting the Tₜₕ₁ time pattern is shown in scenario 1200 of FIG. 12. Here, UE-A 1002 has reserved a first sidelink resource 1204 for transmission of its own PRS and reserved a second sidelink resource 1206 for transmission of a PRS by UE-B 1004, where the time interval Tᵢₙₜ₁ between the first sidelink resource 1104 and second sidelink resource 1106 is less than or equal to Tₜₕ₁.

If UE-A 1002 cannot find candidate resources meeting the first time interval threshold Tₜₕ₁ pattern, or in instances where sidelink resource 1206 has been preempted by a higher priority transmission of another device. UE-A 1004 may attempt to find three sidelink resources for execution of a double-sided positioning operation as shown in FIG. 11. To this end, UE-A 1002 first attempts to locate sidelink resources that can be reserved to execute a symmetric double-sided positioning algorithm. The following equations apply to such a symmetric double-sided positioning algorithm in which UE-A 1002 and UE-B 1004 experience clock drift:

$${\hat{T}}_{RTT} = \frac{1}{2} ( {\hat{τ}}_{A , 1} - {\hat{τ}}_{B , 1} + {\hat{τ}}_{B , 2} - {\hat{τ}}_{A , 2} ) , and$$

$${\hat{T}}_{RTT} = \frac{{e}_{A} + {e}_{B}}{2} {T}_{RTT} + \frac{{e}_{A} - {e}_{B}}{2} ( {τ}_{B , 1} - {τ}_{A , 2} ) .$$

Here, the (τ_{B,1}−τ_{A,2}) term dominates the determination of the \hat{T}_{RTT}. To minimize, \hat{T}_{RTT}, UE-A 1002 reserves three sidelink resources that have a symmetric or nearly symmetric pattern such that the time interval τ_{A,2} is approximately the same as time interval τ_{B,1}. A time pattern of sidelink resources meeting this condition occurs when |τ_{B,1}−τ_{A,2}|≤Tₜₕ₂, where Tₜₕ₂ corresponds to the maximum difference between the time intervals τ_{B,1}, τ_{A,2} needed to meet a desired positioning accuracy. As an example, Tₜₕ₂ may be on the order of 3 msec to 4 msec and still obtain reasonable positioning precision. As an example, for positioning operations requiring a 1 meter (m) accuracy and having a 10% error budget, the maximum value for Tₕᵣₑₛ₁ can be determined as:

$${T}_{th 1} = \frac{1 * 10 \%}{0.1 ppm * c} = 3.3 m sec$$

An example of a resource reservation meeting the Tₜₕ₂ time pattern is shown in scenario 1208 of FIG. 12. Here, UE-A 1002 has reserved a first sidelink resource 1210 for transmission of its own PRS and a second sidelink resource 1212 for transmission of a PRS by UE-B 1004. The first sidelink resource 1210 and second sidelink resources 1212 are separated from one another by time interval Tᵢₙₜ₁. Further, UE-A 1002 has reserved an additional third sidelink resource 1214 for transmission of another of its own PRS, where the third sidelink resource 1214 is separated from the second sidelink resource 1212 by time interval Tᵢₙₜ₂. In accordance with certain aspects of the disclosure, neither interval Tᵢₙₜ₁ does not meet the Tₜₕ₁ criterion (or else the UE-A 1002 would have selected the resource and executed a baseline single-sided positioning algorithm). Rather, the sidelink resources 1210, 1212, and 1214 are reserved by UE-A 1002 based on meeting the Tₜₕ₂ criterion such that |Tᵢₙₜ₁−Tᵢₙₜ₂|≥Tₜₕ₂.

If UE-A 1002 cannot find candidate resources meeting either the Tₜₕ₁ pattern criteria or the Tₜₕ₂ pattern criteria, or in instances where one or more of the sidelink resources 1212 or 1214 have been preempted by a higher priority transmission of another device, UE-A 1002 may attempt to find three sidelink resources for executing an asymmetric double-sided positioning algorithm. With reference to the positioning operations shown in FIG. 12, the following equations apply to an asymmetric double-sided positioning algorithm in which UE-A 1002 and UE-B 1004 experience clock drift:

$${\hat{T}}_{RTT} = {\hat{τ}}_{A , 1} - \frac{{\hat{T}}_{driftRef , A}}{{\hat{τ}}_{B , 1} + {\hat{τ}}_{B , 2}} {\hat{τ}}_{B , 1} , and$$

$${\hat{T}}_{RTT} = {e}_{A} {T}_{RTT} .$$

Under such conditions, the time interval between the first sidelink resource and the last sidelink resource should be no less than a drift-correction reference duration threshold Tₜₕ₃. The duration Tₜₕ₃ should be selected to be long enough to be effective—otherwise the multiplicative correction factor would be a constant 1 and has no effect (e.g., {20,40,80} msec minimum PRS 1 1106 to PRS 2 1110) gap for timing measurement granularity of {4T_{c},8T_{c},16T_{c}}, respectively. As an example, T_{c} can be considered as the smallest time unit that a device can count (e.g., Tc≈0.5 nsec). For a clock drift of 0.1 PPM, 20 msec (e.g., Tₜₕ₃≥20 msec) is needed to run with a 2 nsec (4Tc) difference. Otherwise, there is no difference between denominator and numerator. This condition also applies for other granularities (e.g., 8T_{c},16T_{c}) corresponding to 40 msec and 80 msec thresholds, respectively.

An example of a resource reservation meeting the Tras pattern criterion is shown in scenario 1216 of FIG. 12. Here, UE-A 1002 has reserved a first sidelink resource 1218 for transmission of its own PRS and a second sidelink resource 1220 for transmission of a PRS by UE-B 1004, which are separated from one another by time interval Tᵢₙₜ₁. Further, UE-A 1002 has reserved a third sidelink resource 1222 for transmission of its own PRS, where the third sidelink resource 1214 is separated from the second sidelink resource by time interval Tᵢₙₜ₂. In accordance with certain aspects of the disclosure, interval Tᵢₙₜ₁ does not satisfy the Tₜₕ₁ time pattern (or else UE-A 1002 would have selected the resource and executed a baseline single-sided positioning algorithm). Similarly, the intervals Tᵢₙₜ₁ and Tᵢₙₜ₂ fail to satisfy the Tₜₕ₂ time pattern (or else UE-A 1002 would have selected the resources and executed a baseline single-sided positioning algorithm). Rather, the sidelink resources 1210, 1212, and 1214 are reserved by UE-A 1002 based on meeting the Tₜₕ₃ time pattern such that Tᵢₙₜ₁+Tᵢₙₜ₂=Tᵢₙₜ₃ and Tᵢₙₜ₃≤Tₜₕ₃.

In certain aspects, the sidelink resources used to transmit PRS in any of the foregoing time patterns are transmitted time-division-multiplexed (TDM'ed). As such, PRS 1 1206 and PRS 2 1208 are TDM'ed in sidelink resources 1204 and 1206 in scenario 1200 of FIG. 12. Similarly. PRS 1 1206, PRS 2 1208, and PRS 3 1210 are TDM'ed in sidelink resources 1210, 1212, and 1214 in scenario 1208 of FIG. 12 and TDM'ed in sidelink resources 1218, 1220, and 1222 of scenario 1216. Further, in an aspect, the UE that sends the reservation message (e.g., UE-A 1002) should be the UE that transmits the first PRS (e.g., PRS 1).

With concurrent reference to FIGS. 10 to 12, if sidelink resources meeting the pattern Tₜₕ₁ criterion have been reserved, and sidelink resource 1206 for PRS 2 1208 is preempted, UE-A 1002 attempts to reserve two new sidelink resources satisfying either the Tₜₕ₂ pattern or the Tₜₕ₃ pattern. In such instances, the transmission of PRS 1 1206 and PRS 3 1210 by UE-A 1002 should be based on the same time reference (e.g., the same UE Tx timing error group (TEG)). Tx TEG can be understood with respect to time delays that transmitted signals experience in a UE. From a signal transmission perspective, there is a time delay from the time when the digital signal is generated at the baseband to the time when the RF signal is transmitted from the transmit antenna. For positioning support, the UE may implement an internal calibration/compensation of the transmit time delay for the transmission of the SL-PRS, which may also include the calibration/compensation of the relative time delay between different RF chains in the same UE. The compensation may also consider the offset of the transmit antenna phase center to the physical antenna center. However, the calibration may not be perfect. The remaining transmit time delay after the calibration, or the uncalibrated transmit time delay is defined as the “transmit timing error” or “Tx timing error.” In a UE Tx TEG (or TxTEG), the transmissions of one or more PRS resources transmitted for positioning purposes have transmission timing errors falling within a certain margin (e.g., within a threshold of each other).

In accordance with certain aspects, the measurement report of the Rx-Tx time difference by UE-B 1004 should be based on the same time reference for PRS 1-PRS 2 and for PRS 2-PRS 3 (e.g., should have the same Rx-Tx TEG). From a signal reception perspective, there is a time delay from the time when the RF signal arrives at the receiving antenna to the time when the signal is digitized and time-stamped at the baseband. For supporting positioning, the UE may implement an internal calibration/compensation of the Rx time delay before it reports the measurements that are obtained from the sidelink-PRS SL-PRS, which may also include the calibration/compensation of the relative time delay between different RF chains in the same UE. The compensation may also consider the offset of the Rx antenna phase center to the physical antenna center. However, the calibration may not be perfect. The remaining Rx time delay after the calibration, or the uncalibrated Rx time delay, is defined as the “Rx timing error.” A UE Rx-Tx TEG associated with one or more UE Rx-Tx time difference measurements, and one or more PRS resources for the positioning purpose, which have the Rx timing errors plus Tx timing errors within a certain margin.

In accordance with certain aspects of the disclosure, where sidelink resources satisfying the Tₜₕ₂ time pattern are reserved, if sidelink resource 1212 (e.g., the resource for transmission of PRS 2 1108) and/or sidelink resource 1214 (e.g., the resource for transmission of PRS 3 1110) is preempted, UE-A 1002 can attempt to reserve one or two new sidelink resources satisfying the Tₜₕ₃ time pattern. Similarly, the transmission of PRS 1 1106 and PRS 3 1110 by UE-A 1002 should be based on the same time reference (e.g., the same UE Tx timing error group (TEG)). Also, the Rx-Tx time difference by UE-B 1004 should be based on the same time reference for PRS 1-PRS 2 and for PRS 2-PRS 3 (e.g., should have the same RX-TX TEG).

UE-A 1002 may assign priorities to the sidelink resource reservations. With respect to sidelink resources satisfying the Tₜₕ₁ time pattern, sidelink resource 1204 for transmission of PRS 1 1006 should be assigned a higher priority than sidelink resource 1206 for transmission of PRS 2 1008 (e.g., indicated by a smaller priority value) since UE-A 1002 can still attempt to reserve two new sidelink resources satisfying the Tₜₕ₂ time pattern or the Tₜₕ₃ time pattern for PRS transmissions if sidelink resource 1206 is preempted. As to priorities between three sidelink resources satisfying the Tₜₕ₂ time pattern, sidelink resource 1210 (e.g., the resource used for transmission of PRS 1 1106) and sidelink resource 1212 (e.g., the resource used for transmission of PRS 2 1108) should have higher priorities than sidelink resource 1214 (e.g., the resources used for transmission of PRS 3 1110) since the UE can still attempt to reserve a new sidelink resource that meets the Tₜₕ₃ time pattern for PRS transmissions if sidelink resource 1214 is preempted. As to priorities between sidelink resource reservations satisfying the Tₜₕ₁ time pattern or the Tₜₕ₂ time pattern and resource reservations satisfying the Tₜₕ₃ time pattern, reservations of resources satisfying the Tₜₕ₁ time pattern or the Tₜₕ₂ time pattern can be assigned a higher priority over resource reservations satisfying the Tₜₕ₃ time pattern, since PRS transmitted using resource reservations satisfying the Tₜₕ₃ time pattern are more tolerant of positioning latency.

In accordance with certain aspects of the disclosure, UE-A 1002 may indicate to other UEs that it has reserved one or more sidelink resources on behalf of the other UEs. In at least one aspect, the indication may include a request for the UEs to transmit PRS on the sidelink resources reserved on its behalf. In at least one aspect, the other UEs may be requested to measure PRS transmitted by UE-A 1002 and report such measurements to UE-A 1002.

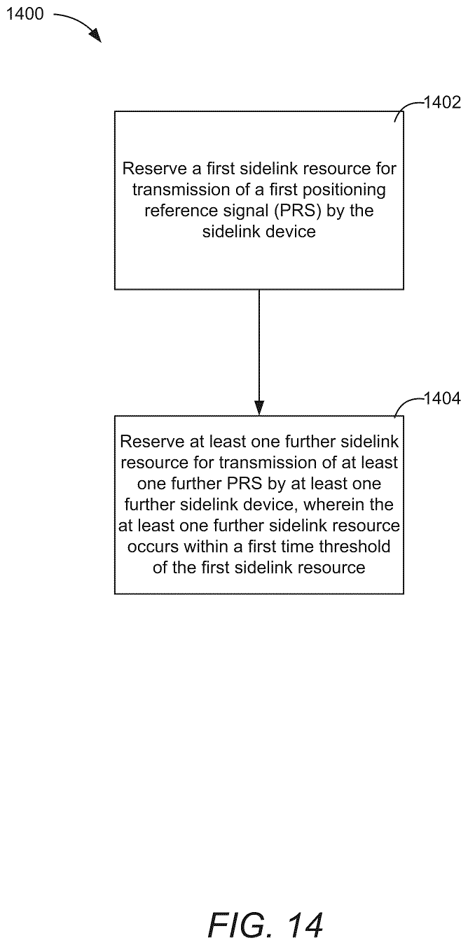

Although the foregoing examples have been described with respect to two UEs, the resource reservation operations and corresponding positioning techniques are also applicable to multi-RTT methods. To this end, UE-A 1002 may reserve sidelink resources for itself and a plurality of other UEs to conduct positioning operations. As an example, UE-A 1002 may reserve sidelink resources for transmission of PRS from multiple additional UEs based on the sidelink resources reserved for each of the additional UEs satisfying one or more of the Tₜₕ₁ time pattern, the Tₜₕ₂ time pattern, and/or the Tₜₕ₃ time pattern. In certain aspects, UE-A 1002 may reserve a first sidelink resource and then identify and reserve sidelink resources that meet one or more of the time patterns with respect to the first sidelink resource. In certain aspects, the additional sidelink resources reserved for the additional UEs are time division multiplexed transmissions (e.g., TDM'ed). However, in accordance with certain aspects of the disclosure, the sidelink resources reserved for the additional UEs may be resources in different subcarriers of the same sub-channel or on subcarriers of resources in different sub-channels of the resource pool where the frequency spacing corresponds to a selected comb pattern. FIG. 14 shows various examples of resource reservation scenarios for multiple UEs on sidelink resources on different subcarriers and/or sub-channels based on a comb pattern in accordance with certain aspects of the disclosure. No specific comb pattern is depicted in the example shown in FIG. 14. Rather, the subcarrier spacing shown in FIG. 14 is merely illustrative to indicate that the identified resources are on different subcarriers rather than showing a specific comb pattern of the subcarriers.

In accordance with certain aspects of the disclosure, UE-A 1002 may reserve sidelink resources in a manner similar to persistent resource reservation. To this end, UE-A 1002 may reserve sidelink resources meeting the time threshold criterion across multiple selection windows, where the sidelink resources arc reserved by UE-A 1002 for different UEs during different selection windows. As such, once sidelink resources meeting a given time threshold criterion are reserved, the same sidelink resource reservations may be used multiple times with different UEs.

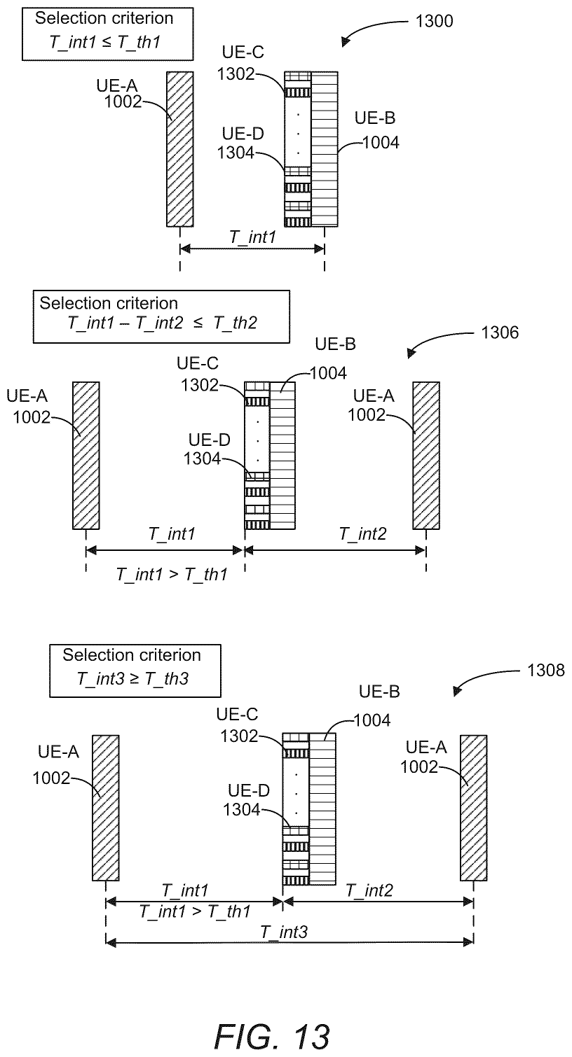

FIG. 13 depicts example resource reservations for multiple UEs (UE-A 1002, UE-B 1004, UE-C 1302, and UE-D 1304) that may be used for multi-RTT positioning measurements. In each scenario of FIG. 13, UE-A 1002 has reserved resources for the multiple UEs in a frequency division multiplexed (FDM'ed) combed pattern, where the reserved resources facilitate interlaced, full-bandwidth transmission of PRS by the multiple UEs. In the example of FIG. 13, scenario 1300 depicts reservations for UE-A 1002, UE-B 1004, UE-C 1302, and UE-D 1304 that satisfy the Tₜₕ₁ time pattern. Scenario 1306 depicts example resource reservations for UE-A 1002, UE-B 1004, UE-C 1302, and UE-D 1304 that satisfy the Tₜₕ₂ time pattern. Scenario 1308 depicts example resource reservations for UE-A 1002, UE-B 1004, UE-C 1302, and UE-D 1304 that satisfy the Tw time pattern. Based on the teachings of the present disclosure, it will be recognized that other sidelink resource combinations may be reserved for multiple UEs that satisfy the various time patterns, the reservations shown in FIG. 13 merely being non-limiting examples.

FIG. 14 illustrates an example method 1400 of wireless communication performed by a sidelink device, according to aspects of the disclosure. At operation 1402, the sidelink device reserves a first sidelink resource for transmission of a first positioning reference signal (PRS) by the sidelink device. In an aspect, operation 1402 may be performed by the one or more transceivers 304, the one or more processors 310, memory 314, and/or sidelink manager 370, any or all of which may be considered means for performing this operation.

At operation 1404, the sidelink device reserves at least one further sidelink resource for transmission of at least one further PRS by at least one further sidelink device, wherein the at least one further sidelink resource occurs within a first time threshold of the first sidelink resource. In an aspect, operation 1404 may be performed by the one or more transceivers 304, the one or more processors 310, memory 314, and/or sidelink manager 370, any or all of which may be considered means for performing this operation.

As will be appreciated, a technical advantage of the method 1400 is that clock drift errors in sidelink devices participating in positioning operations are mitigated when sidelink resources are reserved in the manner specified by the method.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a sidelink device, comprising: reserving a first sidelink resource for transmission of a first positioning reference signal (PRS) by the sidelink device; and reserving at least one further sidelink resource for transmission of at least one further PRS by at least one further sidelink device, wherein the at least one further sidelink resource occurs within a first time threshold of the first sidelink resource.

Clause 2. The method of clause 1, further comprising: sensing for available sidelink resources of a sidelink resource pool; and determining that the first sidelink resource and the at least one further sidelink resource are available for PRS transmissions before reserving the first sidelink resource and the at least one further sidelink resource.

Clause 3. The method of any of clauses 1 to 2, wherein: the first sidelink resource is reserved with a higher priority than the at least one further sidelink resource.

Clause 4. The method of claim 1, wherein: the first sidelink resource and the at least one further sidelink resource are reserved via one or more reservation messages indicated in one or more sidelink control information (SCI) transmissions.

Clause 5. The method of any of clauses 1 to 4, further comprising: transmitting a request for the at least one further sidelink device to transmit the at least one further PRS on the at least one further sidelink resource.

Clause 6. The method of any of clauses 1 to 5, further comprising: transmitting one or more indications that the first sidelink resource and the at least one further sidelink resource are reserved for PRS transmissions from the sidelink device and from the at least one further sidelink device, respectively.

Clause 7. The method of any of clauses 1 to 6, further comprising: transmitting the first PRS on the first sidelink resource; receiving the at least one further PRS from the at least one further sidelink device on the at least one further sidelink resource; and determining a range to the at least one further sidelink device based on a first time-of-flight of the first PRS from the sidelink device to the at least one further sidelink device, and a second time-of-flight of the at least one further PRS from the at least one further sidelink device to the sidelink device.

Clause 8. The method of any of clauses 1 to 7, further comprising: in response to a determination that there are no sidelink resources that occur within the first time threshold of the first sidelink resource, or that the at least one further sidelink resource has been preempted by a higher priority transmission; determining that a second sidelink resource is available for transmission of a second PRS, wherein the second sidelink resource is spaced from the first sidelink resource by a first time interval; determining that a third sidelink resource is available for transmission of a third PRS, wherein the third sidelink resource is spaced a second time interval from the second sidelink resource, wherein a difference between a first duration of the first time interval and a second duration of the second time interval has a magnitude less than a second time threshold; reserving the first sidelink resource for transmission of the first PRS; reserving the second sidelink resource for transmission of the second PRS by a second sidelink device; and reserving the third sidelink resource for transmission of the third PRS by the sidelink device.

Clause 9. The method of clause 8, wherein: the first sidelink resource and the second sidelink resource are reserved with a higher priority than the third sidelink resource.

Clause 10. The method of any of clauses 8 to 9, further comprising: transmitting a request to the second sidelink device to transmit the second PRS on the second sidelink resource and to measure the third PRS on the third sidelink resource.

Clause 11. The method of any of clauses 8 to 10, further comprising: transmitting the first PRS on the first sidelink resource; and transmitting the third PRS on the third sidelink resource, wherein the first PRS and third PRS are transmitted based on a same time reference.

Clause 12. The method of any of clauses 8 to 11, further comprising: in response to a determination that there are no sidelink resources available for selection as the third sidelink resource, or that the third sidelink resource has been preempted by a higher priority transmission; determining that a fourth sidelink resource is available for transmission of a third PRS, wherein the third sidelink resource is spaced from the second sidelink resource by a fourth time interval having a fourth duration, wherein a sum of the first duration and the fourth duration is no greater than a third time threshold; and reserving the fourth sidelink resource for transmission of a third PRS.

Clause 13. The method of clause 12, further comprising: transmitting a request to the second sidelink device to transmit the second PRS on the second sidelink resource and measure the third PRS on the fourth sidelink resource.

Clause 14. The method of any of clauses 12 to 13, further comprising: transmitting the first PRS on the first sidelink resource; and transmitting the third PRS on the third sidelink resource, wherein the first PRS and the third PRS are transmitted based on a same time reference.

Clause 15. The method of any of clauses 1 to 14, further comprising: reserving the at least one further sidelink resource for transmission of additional PRS from one or more additional sidelink devices during different resource selection windows.

Clause 16. The method of any of clauses 1 to 15, further comprising: reserving a plurality of further sidelink resources for transmission of a plurality of further PRS by a plurality of further sidelink devices, wherein each sidelink resource of the plurality of further sidelink resources occurs within the first time threshold of the first sidelink resource.

Clause 17. The method of clause 16, wherein: at least two or more of the further sidelink resources are on a same time resource in a frequency division multiplexed (FDM'ed) comb pattern.

Clause 18. A sidelink device, comprising: a memory; at least one transceiver; and at least one processor communicatively coupled to the memory and the at least one transceiver, the at least one processor configured to: reserve a first sidelink resource for transmission of a first positioning reference signal (PRS) by the sidelink device; and reserve at least one further sidelink resource for transmission of at least one further PRS by at least one further sidelink device, wherein the at least one further sidelink resource occurs within a first time threshold of the first sidelink resource.

Clause 19. The sidelink device of clause 18, wherein the at least one processor is further configured to: sense for available sidelink resources of a sidelink resource pool; and determine that the first sidelink resource and the at least one further sidelink resource are available for PRS transmissions before reserving the first sidelink resource and the at least one further sidelink resource.

Clause 20. The sidelink device of any of clauses 18 to 19, wherein: the first sidelink resource is reserved with a higher priority than the at least one further sidelink resource.

Clause 21. The sidelink device of any of clauses 18 to 20, wherein: the first sidelink resource and the at least one further sidelink resource are reserved via one or more reservation messages indicated in one or more sidelink control information (SCI) transmissions.

Clause 22. The sidelink device of any of clauses 18 to 21, wherein the at least one processor is further configured to: transmit, via the at least one transceiver, a request for the at least one further sidelink device to transmit the at least one further PRS on the at least one further sidelink resource.

Clause 23. The sidelink device of any of clauses 18 to 22, wherein the at least one processor is further configured to: transmit, via the at least one transceiver, one or more indications that the first sidelink resource and the at least one further sidelink resource are reserved for PRS transmissions from the sidelink device and from the at least one further sidelink device, respectively.

Clause 24. The sidelink device of any of clauses 18 to 23, wherein the at least one processor is further configured to: transmit, via the at least one transceiver, the first PRS on the first sidelink resource; receive, via the at least one transceiver, the at least one further PRS from the at least one further sidelink device on the at least one further sidelink resource; and determine a range to the at least one further sidelink device based on a first time-of-flight of the first PRS from the sidelink device to the at least one further sidelink device, and a second time-of-flight of the at least one further PRS from the at least one further sidelink device to the sidelink device.

Clause 25. The sidelink device of any of clauses 18 to 24, wherein the at least one processor is further configured to: in response to a determination that there are no sidelink resources that occur within the first time threshold of the first sidelink resource, or that the at least one further sidelink resource has been preempted by a higher priority transmission; determine that a second sidelink resource is available for transmission of a second PRS, wherein the second sidelink resource is spaced from the first sidelink resource by a first time interval; determine that a third sidelink resource is available for transmission of a third PRS, wherein the third sidelink resource is spaced a second time interval from the second sidelink resource, wherein a difference between a first duration of the first time interval and a second duration of the second time interval has a magnitude less than a second time threshold; reserve the first sidelink resource for transmission of the first PRS: reserve the second sidelink resource for transmission of the second PRS by a second sidelink device; and reserve the third sidelink resource for transmission of the third PRS by the sidelink device.

Clause 26. The sidelink device of clause 25, wherein: the first sidelink resource and the second sidelink resource are reserved with a higher priority than the third sidelink resource.

Clause 27. The sidelink device of any of clauses 25 to 26, wherein the at least one processor is further configured to: transmit, via the at least one transceiver, a request to the second sidelink device to transmit the second PRS on the second sidelink resource and to measure the third PRS on the third sidelink resource.

Clause 28. The sidelink device of any of clauses 25 to 27, wherein the at least one processor is further configured to: transmit, via the at least one transceiver, the first PRS on the first sidelink resource; and transmit, via the at least one transceiver, the third PRS on the third sidelink resource, wherein the first PRS and third PRS are transmitted based on a same time reference.

Clause 29. The sidelink device of any of clauses 25 to 28, wherein the at least one processor is further configured to: in response to a determination that there are no sidelink resources available for selection as the third sidelink resource, or that the third sidelink resource has been preempted by a higher priority transmission; determine that a fourth sidelink resource is available for transmission of a third PRS, wherein the third sidelink resource is spaced from the second sidelink resource by a fourth time interval having a fourth duration, wherein a sum of the first duration and the fourth duration is no greater than a third time threshold; and reserve the fourth sidelink resource for transmission of a third PRS.

Clause 30. The sidelink device of clause 29, wherein the at least one processor is further configured to: transmit, via the at least one transceiver, a request to the second sidelink device to transmit the second PRS on the second sidelink resource and measure the third PRS on the fourth sidelink resource.

Clause 31. The sidelink device of any of clauses 29 to 30, wherein the at least one processor is further configured to: transmit, via the at least one transceiver, the first PRS on the first sidelink resource; and transmit, via the at least one transceiver, the third PRS on the third sidelink resource, wherein the first PRS and the third PRS are transmitted based on a same time reference.

Clause 32. The sidelink device of any of clauses 18 to 31, wherein the at least one processor is further configured to: reserve the at least one further sidelink resource for transmission of additional PRS from one or more additional sidelink devices during different resource selection windows.

Clause 33. The sidelink device of any of clauses 18 to 32, wherein the at least one processor is further configured to: reserve a plurality of further sidelink resources for transmission of a plurality of further PRS by a plurality of further sidelink devices, wherein each sidelink resource of the plurality of further sidelink resources occurs within the first time threshold of the first sidelink resource.

Clause 34. The sidelink device of clause 33, wherein: at least two or more of the further sidelink resources are on a same time resource in a frequency division multiplexed (FDM'ed) comb pattern.

Clause 35. A sidelink device, comprising: means for reserving a first sidelink resource for transmission of a first positioning reference signal (PRS) by the sidelink device; and means for reserving at least one further sidelink resource for transmission of at least one further PRS by at least one further sidelink device, wherein the at least one further sidelink resource occurs within a first time threshold of the first sidelink resource.

Clause 36. The sidelink device of clause 35, further comprising: means for sensing for available sidelink resources of a sidelink resource pool; and means for determining that the first sidelink resource and the at least one further sidelink resource are available for PRS transmissions before reserving the first sidelink resource and the at least one further sidelink resource.

Clause 37. The sidelink device of any of clauses 35 to 36, wherein: the first sidelink resource is reserved with a higher priority than the at least one further sidelink resource.

Clause 38. The sidelink device of any of clauses 35 to 37, wherein: the first sidelink resource and the at least one further sidelink resource are reserved via one or more reservation messages indicated in one or more sidelink control information (SCI) transmissions.

Clause 39. The sidelink device of any of clauses 35 to 38, further comprising: means for transmitting a request for the at least one further sidelink device to transmit the at least one further PRS on the at least one further sidelink resource.

Clause 40. The sidelink device of any of clauses 35 to 39, further comprising: means for transmitting one or more indications that the first sidelink resource and the at least one further sidelink resource are reserved for PRS transmissions from the sidelink device and from the at least one further sidelink device, respectively.

Clause 41. The sidelink device of any of clauses 35 to 40, further comprising: means for transmitting the first PRS on the first sidelink resource; means for receiving the at least one further PRS from the at least one further sidelink device on the at least one further sidelink resource; and means for determining a range to the at least one further sidelink device based on a first time-of-flight of the first PRS from the sidelink device to the at least one further sidelink device, and a second time-of-flight of the at least one further PRS from the at least one further sidelink device to the sidelink device.

Clause 42. The sidelink device of any of clauses 35 to 41, further comprising: in response to a determination that there are no sidelink resources that occur within the first time threshold of the first sidelink resource, or that the at least one further sidelink resource has been preempted by a higher priority transmission; means for determining that a second sidelink resource is available for transmission of a second PRS, wherein the second sidelink resource is spaced from the first sidelink resource by a first time interval; means for determining that a third sidelink resource is available for transmission of a third PRS, wherein the third sidelink resource is spaced a second time interval from the second sidelink resource, wherein a difference between a first duration of the first time interval and a second duration of the second time interval has a magnitude less than a second time threshold; means for reserving the first sidelink resource for transmission of the first PRS; means for reserving the second sidelink resource for transmission of the second PRS by a second sidelink device; and means for reserving the third sidelink resource for transmission of the third PRS by the sidelink device.

Clause 43. The sidelink device of clause 42, wherein: the first sidelink resource and the second sidelink resource are reserved with a higher priority than the third sidelink resource.

Clause 44. The sidelink device of any of clauses 42 to 43, further comprising: means for transmitting a request to the second sidelink device to transmit the second PRS on the second sidelink resource and to measure the third PRS on the third sidelink resource.

Clause 45. The sidelink device of any of clauses 42 to 44, further comprising: means for transmitting the first PRS on the first sidelink resource; and means for transmitting the third PRS on the third sidelink resource, wherein the first PRS and third PRS arm transmitted based on a same time reference.

Clause 46. The sidelink device of any of clauses 42 to 45, further comprising: in response to a determination that there are no sidelink resources available for selection as the third sidelink resource, or that the third sidelink resource has been preempted by a higher priority transmission; means for determining that a fourth sidelink resource is available for transmission of a third PRS, wherein the third sidelink resource is spaced from the second sidelink resource by a fourth time interval having a fourth duration, wherein a sum of the first duration and the fourth duration is no greater than a third time threshold; and means for reserving the fourth sidelink resource for transmission of a third PRS.

Clause 47. The sidelink device of clause 46, further comprising: means for transmitting a request to the second sidelink device to transmit the second PRS on the second sidelink resource and measure the third PRS on the fourth sidelink resource.

Clause 48. The sidelink device of any of clauses 46 to 47, further comprising: means for transmitting the first PRS on the first sidelink resource; and means for transmitting the third PRS on the third sidelink resource, wherein the first PRS and the third PRS are transmitted based on a same time reference.

Clause 49. The sidelink device of any of clauses 35 to 48, further comprising: means for reserving the at least one further sidelink resource for transmission of additional PRS from one or more additional sidelink devices during different resource selection windows.

Clause 50. The sidelink device of any of clauses 35 to 49, further comprising: means for reserving a plurality of further sidelink resources for transmission of a plurality of further PRS by a plurality of further sidelink devices, wherein each sidelink resource of the plurality of further sidelink resources occurs within the first time threshold of the first sidelink resource.

Clause 51. The sidelink device of clause 50, wherein: at least two or more of the further sidelink resources are on a same time resource in a frequency division multiplexed (FDM'ed) comb pattern.

Clause 52. A non-transitory computer-readable medium storing computer-executable instructions that, when executed by a sidelink device, cause the sidelink device to: reserve a first sidelink resource for transmission of a first positioning reference signal (PRS) by the sidelink device; and reserve at least one further sidelink resource for transmission of at least one further PRS by at least one further sidelink device, wherein the at least one further sidelink resource occurs within a first time threshold of the first sidelink resource.

Clause 53. The non-transitory computer-readable medium of clause 52, further comprising computer-executable instructions that, when executed by the sidelink device, cause the sidelink device to: sense for available sidelink resources of a sidelink resource pool; and determine that the first sidelink resource and the at least one further sidelink resource are available for PRS transmissions before reserving the first sidelink resource and the at least one further sidelink resource.

Clause 54. The non-transitory computer-readable medium of any of clauses 52 to 53, wherein: the first sidelink resource is reserved with a higher priority than the at least one further sidelink resource.

Clause 55. The non-transitory computer-readable medium of any of clauses 52 to 54, wherein: the first sidelink resource and the at least one further sidelink resource are reserved via one or more reservation messages indicated in one or more sidelink control information (SCI) transmissions.

Clause 56. The non-transitory computer-readable medium of any of clauses 52 to 55, further comprising computer-executable instructions that, when executed by the sidelink device, cause the sidelink device to: transmit a request for the at least one further sidelink device to transmit the at least one further PRS on the at least one further sidelink resource.

Clause 57. The non-transitory computer-readable medium of any of clauses 52 to 56, further comprising computer-executable instructions that, when executed by the sidelink device, cause the sidelink device to: transmit one or more indications that the first sidelink resource and the at least one further sidelink resource are reserved for PRS transmissions from the sidelink device and from the at least one further sidelink device, respectively.

Clause 58. The non-transitory computer-readable medium of any of clauses 52 to 57, further comprising computer-executable instructions that, when executed by the sidelink device, cause the sidelink device to: transmit the first PRS on the first sidelink resource; receive the at least one further PRS from the at least one further sidelink device on the at least one further sidelink resource; and determine a range to the at least one further sidelink device based on a first time-of-flight of the first PRS from the sidelink device to the at least one further sidelink device, and a second time-of-flight of the at least one further PRS from the at least one further sidelink device to the sidelink device.

Clause 59. The non-transitory computer-readable medium of any of clauses 52 to 58, further comprising computer-executable instructions that, when executed by the sidelink device, cause the sidelink device to: in response to a determination that there are no sidelink resources that occur within the first time threshold of the first sidelink resource, or that the at least one further sidelink resource has been preempted by a higher priority transmission; determine that a second sidelink resource is available for transmission of a second PRS, wherein the second sidelink resource is spaced from the first sidelink resource by a first time interval; determine that a third sidelink resource is available for transmission of a third PRS, wherein the third sidelink resource is spaced a second time interval from the second sidelink resource, wherein a difference between a first duration of the first time interval and a second duration of the second time interval has a magnitude less than a second time threshold; reserve the first sidelink resource for transmission of the first PRS; reserve the second sidelink resource for transmission of the second PRS by a second sidelink device; and reserve the third sidelink resource for transmission of the third PRS by the sidelink device.

Clause 60. The non-transitory computer-readable medium of clause 59, wherein: the first sidelink resource and the second sidelink resource are reserved with a higher priority than the third sidelink resource.

Clause 61. The non-transitory computer-readable medium of any of clauses 59 to 60, further comprising computer-executable instructions that, when executed by the sidelink device, cause the sidelink device to: transmit a request to the second sidelink device to transmit the second PRS on the second sidelink resource and to measure the third PRS on the third sidelink resource.

Clause 62. The non-transitory computer-readable medium of any of clauses 59 to 61, further comprising computer-executable instructions that, when executed by the sidelink device, cause the sidelink device to: transmit the first PRS on the first sidelink resource; and transmit the third PRS on the third sidelink resource, wherein the first PRS and third PRS are transmitted based on a same time reference.

Clause 63. The non-transitory computer-readable medium of any of clauses 59 to 62, further comprising computer-executable instructions that, when executed by the sidelink device, cause the sidelink device to: in response to a determination that there are no sidelink resources available for selection as the third sidelink resource, or that the third sidelink resource has been preempted by a higher priority transmission; determine that a fourth sidelink resource is available for transmission of a third PRS, wherein the third sidelink resource is spaced from the second sidelink resource by a fourth time interval having a fourth duration, wherein a sum of the first duration and the fourth duration is no greater than a third time threshold; and reserve the fourth sidelink resource for transmission of a third PRS.

Clause 64. The non-transitory computer-readable medium of clause 63, further comprising computer-executable instructions that, when executed by the sidelink device, cause the sidelink device to: transmit a request to the second sidelink device to transmit the second PRS on the second sidelink resource and measure the third PRS on the fourth sidelink resource.

Clause 65. The non-transitory computer-readable medium of any of clauses 63 to 64, further comprising computer-executable instructions that, when executed by the sidelink device, cause the sidelink device to: transmit the first PRS on the first sidelink resource; and transmit the third PRS on the third sidelink resource, wherein the first PRS and the third PRS are transmitted based on a same time reference.

Clause 66. The non-transitory computer-readable medium of any of clauses 52 to 65, further comprising computer-executable instructions that, when executed by the sidelink device, cause the sidelink device to: reserve the at least one further sidelink resource for transmission of additional PRS from one or more additional sidelink devices during different resource selection windows.

Clause 67. The non-transitory computer-readable medium of any of clauses 52 to 66, further comprising computer-executable instructions that, when executed by the sidelink device, cause the sidelink device to: reserve a plurality of further sidelink resources for transmission of a plurality of further PRS by a plurality of further sidelink devices, wherein each sidelink resource of the plurality of further sidelink resources occurs within the first time threshold of the first sidelink resource.

Clause 68. The non-transitory computer-readable medium of clause 67, wherein: at least two or more of the further sidelink resources are on a same time resource in a frequency division multiplexed (FDM'ed) comb pattern.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a sidelink device, comprising:
reserving a first sidelink resource for transmission of a first positioning reference signal (PRS) by the sidelink device; and
reserving at least one further sidelink resource for transmission of at least one further PRS by at least one further sidelink device, wherein the at least one further sidelink resource occurs within a first time threshold of the first sidelink resource.

2. The method of claim 1, further comprising:
sensing for available sidelink resources of a sidelink resource pool; and
determining that the first sidelink resource and the at least one further sidelink resource are available for PRS transmissions before reserving the first sidelink resource and the at least one further sidelink resource.

3. The method of claim 1, wherein:
the first sidelink resource is reserved with a higher priority than the at least one further sidelink resource.

4. The method of claim 1, wherein:
the first sidelink resource and the at least one further sidelink resource are reserved via one or more reservation messages indicated in one or more sidelink control information (SCI) transmissions.

5. The method of claim 1, further comprising:
transmitting a request for the at least one further sidelink device to transmit the at least one further PRS on the at least one further sidelink resource.

6. The method of claim 1, further comprising:
transmitting one or more indications that the first sidelink resource and the at least one further sidelink resource are reserved for PRS transmissions from the sidelink device and from the at least one further sidelink device, respectively.

7. The method of claim 1, further comprising:
transmitting the first PRS on the first sidelink resource;
receiving the at least one further PRS from the at least one further sidelink device on the at least one further sidelink resource; and
determining a range to the at least one further sidelink device based on a first time-of-flight of the first PRS from the sidelink device to the at least one further sidelink device, and a second time-of-flight of the at least one further PRS from the at least one further sidelink device to the sidelink device.

8. The method of claim 1, further comprising:
in response to a determination that there are no sidelink resources that occur within the first time threshold of the first sidelink resource, or that the at least one further sidelink resource has been preempted by a higher priority transmission;
determining that a second sidelink resource is available for transmission of a second PRS, wherein the second sidelink resource is spaced from the first sidelink resource by a first time interval;
determining that a third sidelink resource is available for transmission of a third PRS, wherein the third sidelink resource is spaced a second time interval from the second sidelink resource, wherein a difference between a first duration of the first time interval and a second duration of the second time interval has a magnitude less than a second time threshold;
reserving the first sidelink resource for transmission of the first PRS;
reserving the second sidelink resource for transmission of the second PRS by a second sidelink device; and
reserving the third sidelink resource for transmission of the third PRS by the sidelink device.

9. The method of claim 8, wherein:
the first sidelink resource and the second sidelink resource are reserved with a higher priority than the third sidelink resource.

10. The method of claim 8, further comprising:
transmitting a request to the second sidelink device to transmit the second PRS on the second sidelink resource and to measure the third PRS on the third sidelink resource.

11. The method of claim 8, further comprising:
transmitting the first PRS on the first sidelink resource; and
transmitting the third PRS on the third sidelink resource, wherein the first PRS and third PRS are transmitted based on a same time reference.

12. The method of claim 8, further comprising:
in response to a determination
that there are no sidelink resources available for selection as the third sidelink resource, or
that the third sidelink resource has been preempted by a higher priority transmission;
determining that a fourth sidelink resource is available for transmission of a third PRS, wherein the third sidelink resource is spaced from the second sidelink resource by a fourth time interval having a fourth duration, wherein a sum of the first duration and the fourth duration is no greater than a third time threshold; and
reserving the fourth sidelink resource for transmission of a third PRS.

13. The method of claim 12, further comprising:
transmitting a request to the second sidelink device to transmit the second PRS on the second sidelink resource and measure the third PRS on the fourth sidelink resource.

14. The method of claim 12, further comprising:
transmitting the first PRS on the first sidelink resource; and
transmitting the third PRS on the third sidelink resource, wherein the first PRS and the third PRS are transmitted based on a same time reference.

15. The method of claim 1, further comprising:
reserving the at least one further sidelink resource for transmission of additional PRS from one or more additional sidelink devices during different resource selection windows.

16. The method of claim 1, further comprising:
reserving a plurality of further sidelink resources for transmission of a plurality of further PRS by a plurality of further sidelink devices, wherein each sidelink resource of the plurality of further sidelink resources occurs within the first time threshold of the first sidelink resource.

17. The method of claim 16, wherein:
at least two or more of the further sidelink resources are on a same time resource in a frequency division multiplexed (FDM'ed) comb pattern.

18. A sidelink device, comprising:
a memory;
at least one transceiver; and
at least one processor communicatively coupled to the memory and the at least one transceiver, the at least one processor configured to:
reserve a first sidelink resource for transmission of a first positioning reference signal (PRS) by the sidelink device; and
reserve at least one further sidelink resource for transmission of at least one further PRS by at least one further sidelink device, wherein the at least one further sidelink resource occurs within a first time threshold of the first sidelink resource.

19. The sidelink device of claim 18, wherein the at least one processor is further configured to:
sense for available sidelink resources of a sidelink resource pool; and
determine that the first sidelink resource and the at least one further sidelink resource are available for PRS transmissions before reserving the first sidelink resource and the at least one further sidelink resource.

20. The sidelink device of claim 18, wherein:
the first sidelink resource is reserved with a higher priority than the at least one further sidelink resource.

21. The sidelink device of claim 18, wherein:
the first sidelink resource and the at least one further sidelink resource are reserved via one or more reservation messages indicated in one or more sidelink control information (SCI) transmissions.

22. The sidelink device of claim 18, wherein the at least one processor is further configured to:
transmit, via the at least one transceiver, a request for the at least one further sidelink device to transmit the at least one further PRS on the at least one further sidelink resource.

23. The sidelink device of claim 18, wherein the at least one processor is further configured to:
transmit, via the at least one transceiver, one or more indications that the first sidelink resource and the at least one further sidelink resource are reserved for PRS transmissions from the sidelink device and from the at least one further sidelink device, respectively.

24. The sidelink device of claim 18, wherein the at least one processor is further configured to:
in response to a determination that there are no sidelink resources that occur within the first time threshold of the first sidelink resource, or that the at least one further sidelink resource has been preempted by a higher priority transmission:
determine that a second sidelink resource is available for transmission of a second PRS, wherein the second sidelink resource is spaced from the first sidelink resource by a first time interval;
determine that a third sidelink resource is available for transmission of a third PRS, wherein the third sidelink resource is spaced a second time interval from the second sidelink resource, wherein a difference between a first duration of the first time interval and a second duration of the second time interval has a magnitude less than a second time threshold;
reserve the first sidelink resource for transmission of the first PRS;
reserve the second sidelink resource for transmission of the second PRS by a second sidelink device; and
reserve the third sidelink resource for transmission of the third PRS by the sidelink device.

25. The sidelink device of claim 24, wherein:
the first sidelink resource and the second sidelink resource are reserved with a higher priority than the third sidelink resource.

26. The sidelink device of claim 24, wherein the at least one processor is further configured to:
in response to a determination that there are no sidelink resources available for selection as the third sidelink resource, or that the third sidelink resource has been preempted by a higher priority transmission;
determine that a fourth sidelink resource is available for transmission of a third PRS, wherein the third sidelink resource is spaced from the second sidelink resource by a fourth time interval having a fourth duration, wherein a sum of the first duration and the fourth duration is no greater than a third time threshold; and
reserve the fourth sidelink resource for transmission of a third PRS.

27. The sidelink device of claim 18, wherein the at least one processor is further configured to:
reserve the at least one further sidelink resource for transmission of additional PRS from one or more additional sidelink devices during different resource selection windows.

28. The sidelink device of claim 18, wherein the at least one processor is further configured to:
reserve a plurality of further sidelink resources for transmission of a plurality of further PRS by a plurality of further sidelink devices, wherein each sidelink resource of the plurality of further sidelink resources occurs within the first time threshold of the first sidelink resource.

29. A sidelink device, comprising:
means for reserving a first sidelink resource for transmission of a first positioning reference signal (PRS) by the sidelink device; and
means for reserving at least one further sidelink resource for transmission of at least one further PRS by at least one further sidelink device, wherein the at least one further sidelink resource occurs within a first time threshold of the first sidelink resource.

30. A non-transitory computer-readable medium storing computer-executable instructions that, when executed by a sidelink device, cause the sidelink device to:
reserve a first sidelink resource for transmission of a first positioning reference signal (PRS) by the sidelink device; and
reserve at least one further sidelink resource for transmission of at least one further PRS by at least one further sidelink device, wherein the at least one further sidelink resource occurs within a first time threshold of the first sidelink resource.
